(19) United States
(12) Patent Application Publication
(10) Pub. No.: US 2010/0023867 A1
(43) Pub. Date: Jan. 28, 2010

(54) SYSTEMS AND METHODS FOR FILTERING NETWORK DIAGNOSTIC STATISTICS

(75) Inventors: Dale B. Coldiron, San Jose, CA (US); Genti Cuni, Mountain View, CA (US)

Correspondence Address: Workman Nydegger;1000 Eagle Gate Tower, 60 East South Temple, Salt Lake City, UT, 84111, US

(73) Assignee: VIRTUAL INSTRUMENTS CORPORATION, Scotts Valley, CA (US)

(21) Appl. No.: 12/361,402

(22) Filed: Jan. 28, 2009

Related U.S. Application Data
(60) Provisional application No. 61/024,392, filed on Jan. 29, 2008.

(51) Int. Cl. G06F 15/16; G06F 3/048

(52) U.S. Cl. 715/736

(57) ABSTRACT

A computing device is configured to display a user interface. The user interface is configured to create a filter configured to be applied to network diagnostic statistics prior to aggregation of the network diagnostic statistics. The filter includes at least one device data limitation and at least one performance data limitation.

### CROSS-REFERENCE TO RELATED APPLICATIONS

This application claims the benefit of U.S. Provisional Patent Application Ser. No. 61/024,392, entitled SYSTEMS AND METHODS FOR FILTERING NETWORK DIAGNOSTIC STATISTICS, filed Jan. 29, 2008, and incorporated herein in its entirety by this reference.

### BACKGROUND

1. The Field of the Invention

The present invention generally relates to network diagnostic systems and methods and, in particular, network diagnostic systems and methods for filtering network diagnostic data.

2. The Relevant Technology

Computer and data communications networks continue to proliferate due to declining costs, increasing performance of computer and networking equipment, and increasing demand for communication bandwidth. Communications networks—including wide area networks (“WANs”), local area networks (“LANs”), metropolitan area networks (“MANs”), and storage area networks (“SANs”)—allow increased productivity and use of distributed computers or stations through the sharing of resources, the transfer of voice and data, and the processing of voice, data and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks. A variety of network diagnostic systems and methods have been developed to test these networks.

### BRIEF SUMMARY OF THE INVENTION

One aspect is a computing device that may be configured to display a user interface. The user interface may be configured to create a filter configured to be applied to network diagnostic statistics prior to aggregation of the network diagnostic statistics. The filter may include at least one device data limitation and at least one performance data limitation.

Another aspect is a computing device that may be configured to display a user interface. The user interface may be configured to create a filter configured to be applied to network diagnostic statistics prior to aggregation of the network diagnostic statistics, after aggregation of the network diagnostic statistics or before and after aggregation of the network diagnostic statistics. The filter may include at least one device data limitation and at least one performance data limitation.

For purposes of summarizing, some aspects, advantages and features of a few of the embodiments of the invention have been described in this summary. Some embodiments of the invention may include some or all of these summarized aspects, advantages and features. However, not necessarily all of (or any of) these summarized aspects, advantages or features will be embodied in any particular embodiment of the invention. Thus, none of these summarized aspects, advantages and features is essential. Some of these summarized aspects, advantages and features and other aspects, advantages and features may become more fully apparent from the following detailed description and the appended claims.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram of an exemplary system in accordance with the principles of the present invention;

FIG. 2 illustrates aspects of exemplary user interfaces in accordance with the principles of the present invention;

FIG. 3 illustrates aspects of exemplary user interfaces in accordance with the principles of the present invention;

FIG. 4 illustrates aspects of exemplary user interfaces in accordance with the principles of the present invention;

FIG. 5 illustrates aspects of exemplary user interfaces in accordance with the principles of the present invention;

FIG. 6 illustrates aspects of exemplary user interfaces in accordance with the principles of the present invention; and

FIG. 7 illustrates a method for aggregating and filtering network diagnostic statistics in a three tier diagnostic system.

### DETAILED DESCRIPTION

Certain embodiments relate generally to networking systems, including the testing of high speed data transmission systems and components. Embodiments of the invention may be used in other contexts unrelated to testing systems and components and/or in other contexts unrelated to high speed data transmission.

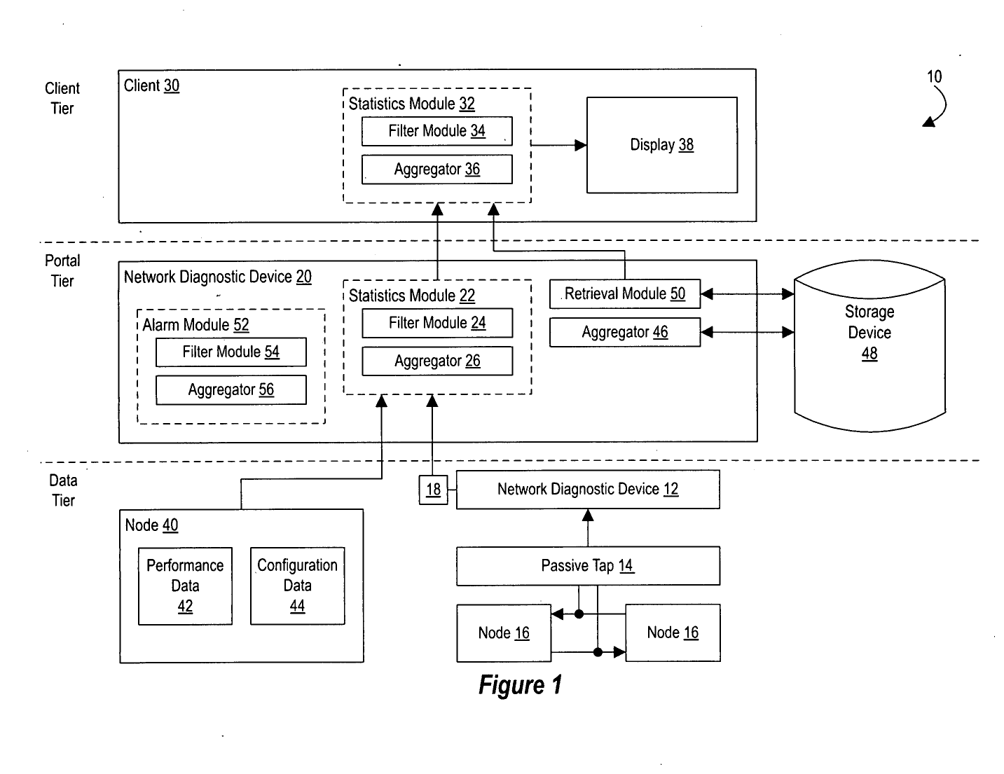

The networking system 10 shown in FIG. 1 may comprise a network, a network diagnostic system, and/or any other suitable networking system. The networking system 10 may include one or more nodes. As used herein, a “node” includes, but is not limited to, a server or host; a client or storage device; a switch (such as a physical layer switch or other type of switch); a hub; a router; all or a portion of a SAN fabric; a diagnostic device; and any device that may be coupled to a network and that may receive and/or monitor a signal or data over at least a portion of a network, that may send and/or generate a signal or data over at least a portion of a network, or both.

The nodes may use a signal (such as, an optical signal) to send and/or receive network messages over at least a portion of the networking system 10. As used herein, a “network message” includes, but is not limited to, a packet; a datagram; a frame; a data frame; a command frame; an ordered set; any unit of data capable of being routed (or otherwise transmitted) through a network; and the like. In one embodiment, a network message may comprise transmission characters used for data purposes, protocol management purposes, code violation errors, and the like. Also, an ordered set may include, a Start of Frame (“SOF”), an End of Frame (“EOF”), an Idle, a Receiver Ready (“R_RDY”), a Loop Initialization Primitive (“LIP”), an Arbitrate (“ARB”), an Open (“OPN”), and Close (“CLS”)—such as, those used in certain versions of Fibre Channel. Of course, any ordered sets and/or any network messages of any other size, type, configuration and/or protocol may be used.

The nodes may communicate using any suitable network protocol, including, but not limited to, serial protocols, physical layer protocols, channel protocols, packet-switching protocols, circuit-switching protocols, Ethernet, Fast Ethernet, Gigabit Ethernet, 10 Gigabit Ethernet, Fibre Channel, Fibre Channel Arbitrated Loop (“FC-AL”), Small Computer System Interface (“SCSI”), High Performance Parallel Interface (“HIPPI”), Serial Attached SCSI (“SAS”), Serial ATA (“SATA”), SAS/SATA, Serial SCSI Architecture (“SSA”), and the like.

In some embodiments, one or more components of the networking system 10 may be embodied as part of a multi-tiered distributed system. For example, as shown in FIG. 1, the networking system 10 may include a data tier, a portal tier and a client tier as discussed in further detail below.

The data tier preferably includes one or more network diagnostic devices, such as a network diagnostic device 12. The network diagnostic device 12 may monitor physical data present on a network medium and may generate network diagnostic statistics (such as, performance data, configuration data and/or data relating to node communication) for discrete intervals of time, such as, for one-second intervals or any other desired interval. For example, the network diagnostic device 12 may use a passive tap 14 to monitor the physical data present on a network medium via which nodes 16 communicate, and the network diagnostic device 12 may generate one or more packets or other data containers 18 indicating various network diagnostic statistics for each interval. If desired, the network diagnostic device 12 may not generate any data containers 18 for some intervals, but may generate several data containers 18 for other intervals depending, for example, upon the particular data present on the network medium and/or the particular configuration of the network diagnostic device 12. In some embodiments, a network diagnostic statistic of a data container 18 may be associated with multi-interval storage I/O transactions between nodes 16 communicating via a SAN or other any other type of network. For instance, the nodes 16 may include an initiator and a target, and the network diagnostic statistic of the data container 18 may be associated with the initiator, the target and/or a logical unit number (LUN) of the target. If desired, the network diagnostic device 12 may generate these data containers 18 in substantially real time and thus may be able to continuously generate them from the network traffic as fast as the traffic occurs within the network. After generating the data containers 18, the network diagnostic device 12 may send the data containers 18 to the portal tier as shown in FIG. 1.

As shown in FIG. 1, the portal tier may receive the data containers 18 from the data tier, may filter and/or aggregate the network diagnostic statistics of the data containers 18, and may send the filtered and/or aggregated network diagnostic statistics to the client tier. In some instances, filtering may occur before the aggregation, after the aggregation, or both before and after the aggregation. In other instances, the portal tier may send the network diagnostic statistics of the data containers 18 to the client tier filtered but not aggregated, aggregated but not filtered, or neither filtered nor aggregated, if desired.

In further detail, the portal tier preferably includes one or more network diagnostic devices 20, which may comprise a server computing device running software. A network diagnostic device 20 may include a statistics module 22 that may include a filter module 24 and an aggregator 26. The filter module 24 may “filter out” and/or “filter in” network diagnostic statistics. The aggregator 26 may aggregate network diagnostic statistics. Significantly, the filter module 24 may perform filtering before the aggregation, after the aggregation, or both before and after the aggregation. For example, the filter module 24 may “filter out” and/or “filter in” network diagnostic statistics of the data containers 18, and if desired, the aggregator 26 may then aggregate the filtered network diagnostic statistics. Also, the aggregator 26 may aggregate network diagnostic statistics of the data containers 18, and if desired, the filter module 24 may “filter out” and/or “filter in” the aggregated network diagnostic statistics. In addition, the filter module 24 may “filter out” and/or “filter in” network diagnostic statistics of the data containers 18, the aggregator 26 may then aggregate the filtered network diagnostic statistics, and the filter module 24 may “filter out” and/or “filter in” the aggregated network diagnostic statistics. Of course, in some instances, the filter module 24 need not filter and/or the aggregator need not aggregate the network diagnostic statistics depending upon the particular configuration of the statistics module 22. After the filtering and/or the aggregating, the network diagnostic device 20 may send the network diagnostic statistics to the client tier using, for example, one or more packets or other data containers (like the data containers 18) or any other suitable means.

As shown in FIG. 1, the client tier may receive the network diagnostic statistics from the portal tier, may filter and/or aggregate the network diagnostic statistics, and may display the network diagnostic statistics to a user. In some instances, filtering may occur before the aggregation, after the aggregation, or both before and after the aggregation. In other instances, the client tier may display the network diagnostic statistics without filtering them, without aggregating them, or without filtering or aggregating them, if desired.

In further detail, the client tier preferably includes one or more network clients 30, which may comprise a client computing device running software. A client 30 may include a statistics module 32 that may include a filter module 34 and an aggregator 36. The filter module 34 may “filter out” and/or “filter in” network diagnostic statistics. The aggregator 36 may aggregate network diagnostic statistics. Significantly, the filter module 34 may perform filtering before the aggregation, after the aggregation, or both before and after the aggregation. For example, the filter module 34 may “filter out” and/or “filter in” network diagnostic statistics received from the portal tier, and if desired, the aggregator 36 may then aggregate the filtered network diagnostic statistics. Also, the aggregator 36 may aggregate network diagnostic statistics network diagnostic statistics received from the portal tier, and if desired, the filter module 34 may “filter out” and/or “filter in” the aggregated network diagnostic statistics. In addition, the filter module 34 may “filter out” and/or “filter in” network diagnostic statistics network diagnostic statistics received from the portal tier, the aggregator 36 may then aggregate the filtered network diagnostic statistics, and the filter module 34 may “filter out” and/or “filter in” the aggregated network diagnostic statistics. Of course, in some instances, the filter module 34 need not filter and/or the aggregator need not aggregate the network diagnostic statistics network diagnostic statistics received from the portal tier depending upon the particular configuration of the statistics module 32. After the filtering and/or the aggregating, the network diagnostic device 20 may send the network diagnostic statistics to a display 38 (such as a monitor) for viewing by a user.

As shown above, the network diagnostic device 12 of the data tier may generate network diagnostic statistics, which may be sent to the portal tier. The network diagnostic statistics from the data tier, however, need not be sent by the network diagnostic device 12 alone. For example, a node 40 (such as a switch or other node) may store and/or maintain network diagnostic statistics (such as, performance data 42, configuration data 44 and/or data relating to node communication) and may send the network diagnostic statistics directly to the portal tier.

As shown in FIG. 1, the network diagnostic device 20 may also include an aggregator 46. The aggregator 46 may receive a copy of the data containers 18 and may aggregate the network diagnostic statistics of the data containers, for example, according to a desired interval of time (such as every minute, every five minutes, etc.). The network diagnostic device 20 may likewise aggregate and store the network diagnostic statistics from the node 40 in the storage device 48. The network diagnostic device 20 may store the aggregated network diagnostic statistics in a storage device 48, for example, in a database stored on the storage device 48. If desired, the network diagnostic device 20 may retrieve the aggregated network diagnostic statistics in the storage device 48, reaggregate it for a larger interval of time (such as, hourly, daily, weekly, etc.) and store the reaggregated network diagnostic statistics in the storage device 48.

In response to a request from the client 30, the network diagnostic device 20 may provide, to the client 30, the network diagnostic statistics stored in the storage device 48 for use in reporting. In particular, the client 30 may request the network diagnostic statistics. In response, a retrieval module 50 may retrieve the statistics from the storage device 48 and may send the statistics to the client, which may use the display 38 to present the statistics in a report.

If desired, the network diagnostic statistics presented in the report may be filtered and/or aggregated by the network diagnostic device 20, the client 30 or both. For example, the retrieval module 50 may filter and/or aggregate the statistics before sending them to the client 30; and/or the statistics module 32 may filter and/or aggregate the statistics received from the retrieval module 50. If the statistics are stored in an SQL or other type of database on the storage device 48, the retrieval module 50 may, if desired, generate SQL or other query statements to filter and/or aggregate the statistics before sending them to the client 30. Like the realtime statistics discussed above, the network diagnostic statistics presented in the report may be filtered, aggregated, filtered then aggregated, filtered then aggregated then filtered again, aggregated then filtered, or not aggregated and not filtered by the network diagnostic device 20, the client 30 or both.

As shown in FIG. 1, the network diagnostic device 20 may also include an alarm module 52. The alarm module 52 may receive a copy of the data containers 18 and the network diagnostic statistics from the node 40. In response to detecting one or more conditions indicated by the network diagnostic statistics of the data containers 18 and/or from the node 40, the alarm module 52 may send an email alert, trigger a network diagnostic device to execute a bit sequence capture, send an alarm to the client 30 for presentation to a user via the display 38, and/or take other suitable actions. In some instances, the alarm module 52 may filter and/or aggregate the network diagnostic statistics and may detect the conditions using the filtered and/or aggregated data. In particular, the alarm module 52 may use a filter module 54 and an aggregator 56 to filter, aggregate, filter then aggregate, filter then aggregate then filter again, or aggregate then filter the network diagnostic statistics. Of course, the alarm module 56 need not filter or aggregate the network diagnostic statistics in some instances.

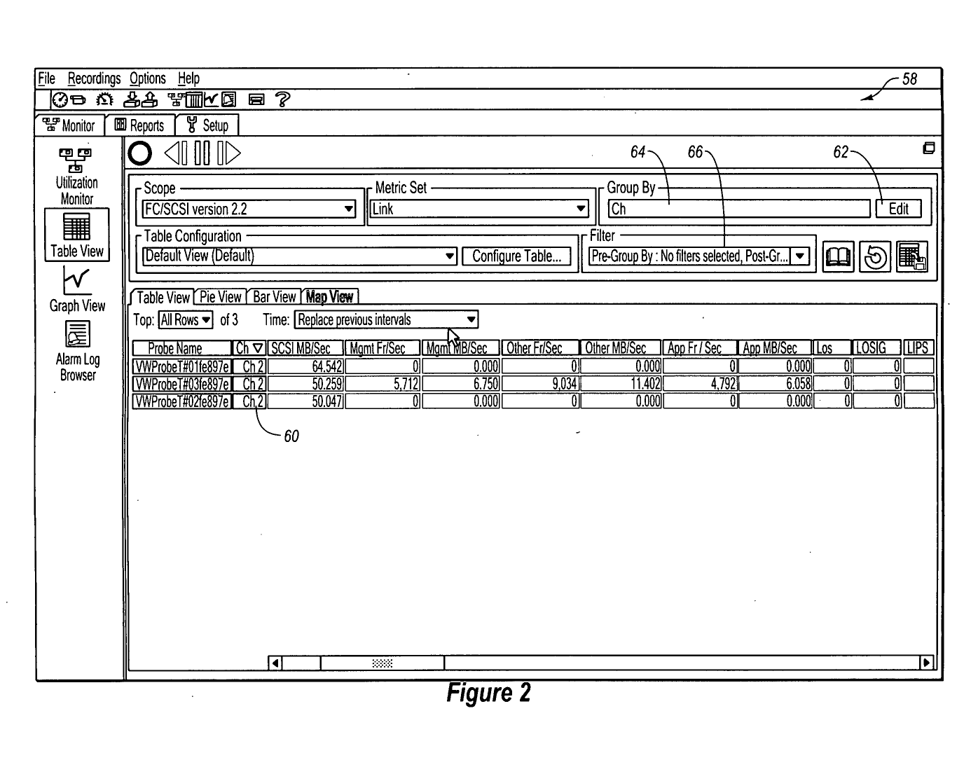

The client 30 shown in FIG. 1 may be configured to present an exemplary user interface 58 (FIGS. 2-6) using the display 38. Desirably, the user interface 58 may include one or more user interface elements that may be used to configure the statistics module 22, the statistics module 32, the retrieval module 50, the alarm module 52, or any combination thereof to filter and/or aggregate network diagnostic statistics as described above.

As shown in FIG. 2, the user interface 58 may display real-time network diagnostic statistics using a table 60, a graph or pie chart, or any other suitable format; and the real-time network diagnostic statistics may be aggregated. In particular, a button 62 or other user interface element may be selected to open a window permitting a user to select a manner by which the displayed real time network diagnostic statistics are aggregated in the display. In response to the user's selection, the client 30 may display the selected aggregation in a field 64 or other user interface element and may configure the aggregator 26 and/or the aggregator 36 to aggregate real time network diagnostic statistics accordingly. The real time network diagnostic statistics may be aggregated by, for example, initiator, target, a logical unit number (LUN) of the target, channel, network diagnostic device 12, other factors or any combination thereof.

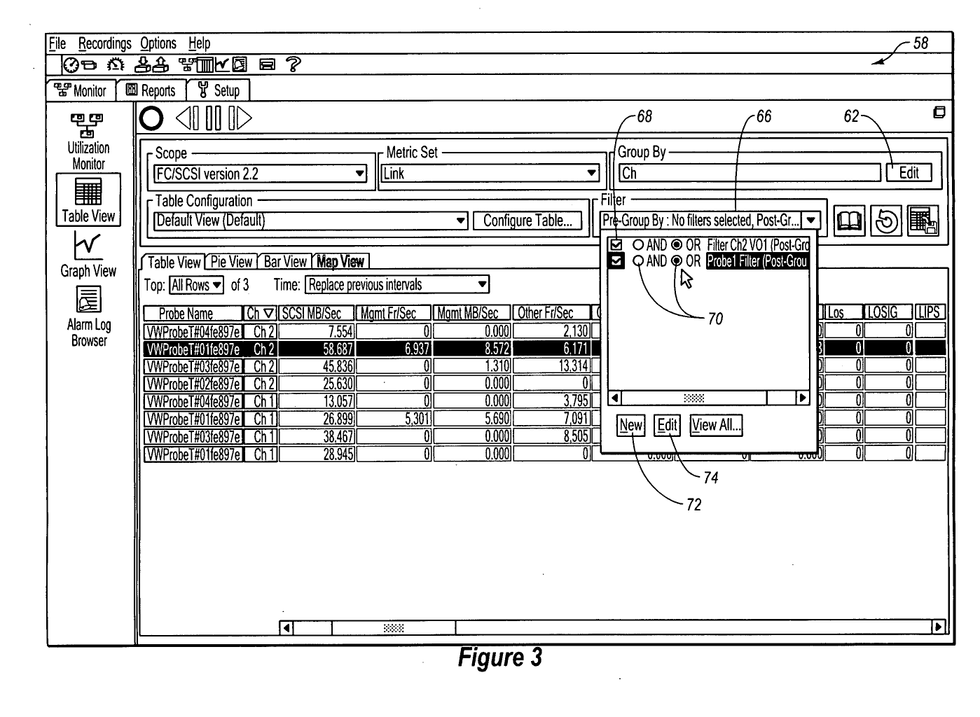

As shown in FIGS. 2-3, a user interface element 66 may be selected to choose one or more filters to be applied to the real-time network diagnostic statistics. In particular, to select a particular filter, a checkbox 68 or other user interface element associated with the filter may be selected. Where multiple filters are listed, radio buttons 70 or other user interface elements may be used to select whether the filters to be applied to the real-time network diagnostic statistics must each be applied (“AND”) or may be alternatively be applied (“OR”). In response to the user's selection, the client 30 may configure the filter module 24 and/or the filter module 34 to filter real time network diagnostic statistics accordingly.

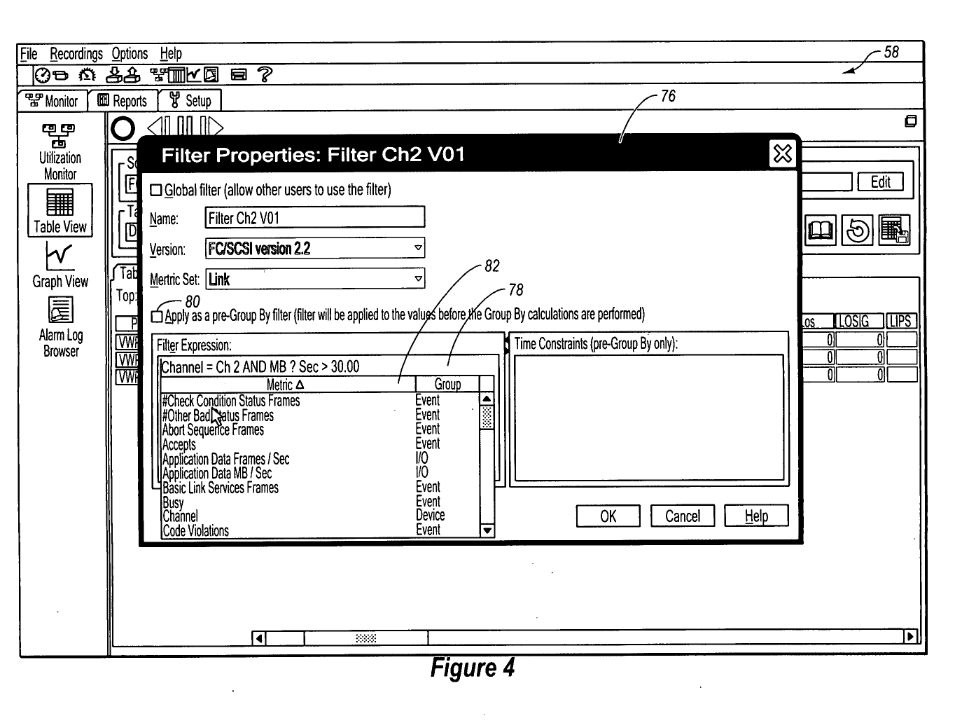

To create a new filter or edit an existing filter, the buttons 72, 74 (or other user interface elements) may be selected. In response to this selection, a user interface 76 (FIG. 4) may be opened. As shown in FIG. 4, the user interface 76 may include a field 78 or other user interface element in which a filter expression for the filter may be edited. The user interface 76 may also include a checkbox 80 or other user interface element. In response to the checkbox 80 being selected, the client 30 may configure the filter module 24 and/or the filter module 34 to apply the filter expression to the real time network diagnostic statistics before any aggregation indicated in the field 64 (FIG. 2) is applied. In response to the checkbox 80 not being selected, the client 30 may configure the filter module 24 and/or the filter module 34 to apply the filter expression to the real time network diagnostic statistics after any aggregation indicated in the field 64 (FIG. 2) is applied. Thus, the user interface 76 advantageously help provide pre-aggregation and post-aggregation filtering. Moreover, as shown in FIG. 4, the filter expression in the field 78 may include a combination of performance data limitations (such as, metrics, event data, etc.) and device data limitations (such as, initiator, target, a LUN of the target, channel, network diagnostic device identifier, network diagnostic device type, initiator type, target type, etc.). Thus, the user interface 76 advantageously provides pre-aggregation and post-aggregation filtering based upon performance data limitations, device data limitations or both.

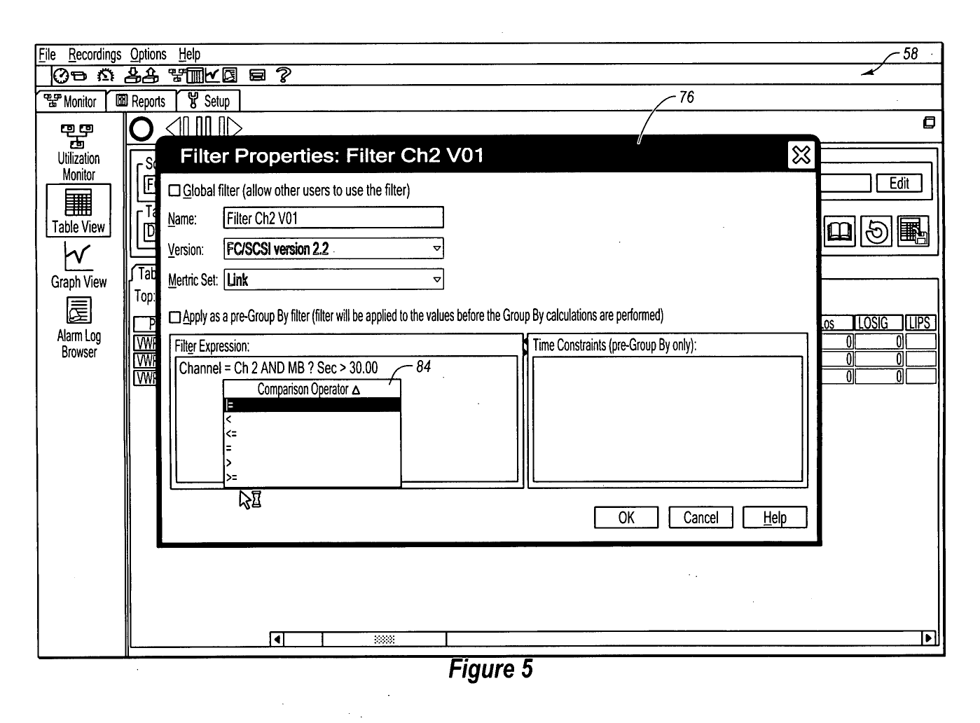

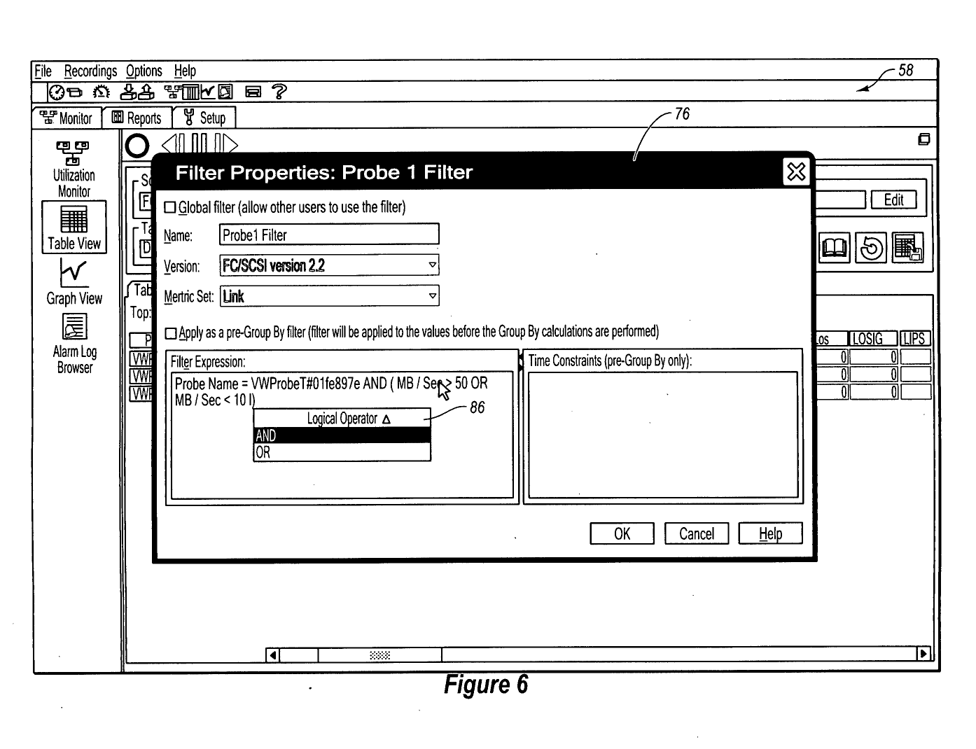

Desirably, the user interface 76 may include a variety of menus to facilitate creation and/or editing of the filter expression of the field 78. For instance, the performance data and device data may be selected using a menu 82 as shown in FIG. 4, comparison operators may be selected using a menu 84 as shown in FIG. 5, and logical/boolean operators may be selected using a menu 86 as shown in FIG. 6. As shown in FIG. 6, the filter expression may include parentheses in combination with any combination of logical and comparison operators, which provides greater flexibility in creating filter expressions.

If desired, the user interface 58 may display the stored network diagnostic statistics from the storage device 48 using a table 60, a graph or pie chart, or any other suitable reporting format. Desirably, the user interfaces 58, 76 may be used to create and select filters and aggregations for the stored network diagnostic statistics in the same or similar manner as done for the real time network diagnostic statistics received by the client 30 by configuring the filter module 34, the aggregator 36 and/or the retrieval module 50 accordingly.

Moreover, the user interfaces 58, 76 may be used to create and select filters and aggregations for the real time network diagnostic statistics received by the alarm module 52 in the same or similar manner as done for the real time network diagnostic statistics received by the client 30 by configuring the filter module 54 and/or the aggregator 56 accordingly.

As shown above, the data tier may generate network diagnostic statistics, which may be filtered and/or aggregated (e.g. by the portal tier, by the client tier or by both) and which may be displayed at the client tier. If desired, this process may be performed in substantially real time and thus such statistics may continuously displayed at the client tier as fast as the traffic occurs within the network.

In one embodiment, the filter expression entered into the field 78 of the user interface 76 may be stored in an XML formatted file. Significantly, this may allow a user to edit the XML file formatted file directly to edit the filter expression to add other expressions, data and/or values to the filter expression (for instance, expressions, data and/or values from external systems).

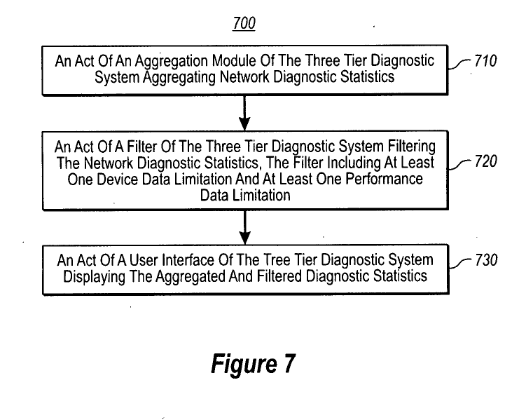

FIG. 7 illustrates a method 700 for aggregating and filtering network diagnostic statistics in a three tier diagnostic system. The method will be described in relation to the environment previously described in relation to FIGS. 1-6, although it will be appreciated that method 700 may be practiced in other environments. At 710 an aggregation module of the three tier diagnostic system performs an act of aggregating network diagnostic statistics. For example, aggregator 26, 36, 46, or 56 may aggregate network diagnostic statistics received from network device 12, node 40, and/or storage device 48 as previously described. At 720, a filter of the three tier diagnostic system performs an act of filtering the network diagnostic statistics. The filter includes at least one device data limitation and at least one performance data limitation. For example, the filter 24, 34, or 54 may filter the network diagnostic statistics after they have been aggregated at 710. The filter may use at least one device data limitation and at least one performance data limitation 78 as previously described. In some embodiments, aggregator 26, 36, 46, or 56 may aggregate the network diagnostic statistics after they have been filtered. At 730 a user interface of the three tier diagnostic system performs an act of displaying the aggregated and filtered diagnostic statistics. For example, the display 38 may display a user interface shown in FIGS. 2-6 as previously described.

The methods and systems described above require no particular component or function. Thus, any described component or function—despite its advantages—is optional. Also, some or all of the described components and functions described above may be used in connection with any number of other suitable components and functions.

Although this invention has been described in terms of certain preferred embodiments, other embodiments apparent to those of ordinary skill in the art are also within the scope of this invention. Accordingly, the scope of the invention is intended to be defined only by the claims which follow.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a computing device configured to display a user interface, the user interface configured to create a filter configured to be applied to network diagnostic statistics prior to aggregation of the network diagnostic statistics, the filter including at least one device data limitation and at least one performance data limitation.

2. The system in accordance with claim 1, wherein the filter is also applied to the network diagnostic statistics after aggregation of the network diagnostic statistics.

3. The system in accordance with claim 1, wherein the at least one performance data limitation is one of metrics or event data.

4. The system in accordance with claim 1, wherein the at least one device data limitation is one of an initiator, target, a LUN of the target, channel, a network diagnostic device identifier, a network diagnostic device type, a initiator type, or a target type.

5. The system in accordance with claim 1, wherein the system is a three tier system including a data tier, portal tier, and client tier, wherein the filter is located in the portal tier.

6. The system in accordance with claim 1, wherein the system is a three tier system including a data tier, portal tier, and client tier, wherein the filter is located in the portal tier.

7. The system in accordance with claim 1, wherein the system is a three tier system including a data tier, portal tier, and client tier, wherein the filter is located in the client tier.

8. The system in accordance with claim 1, wherein the system is a three tier system including a data tier, portal tier, and client tier, wherein the aggregation is performed by an aggregation module that is located in the portal tier.

9. The system in accordance with claim 1, wherein the system is a three tier system including a data tier, portal tier, and client tier, wherein the aggregation is performed by an aggregation module that is located in the client tier.

10. A network diagnostic method for aggregating and filtering network diagnostic statistics in a three tier diagnostic system, the method comprising:
an act of an aggregation module of the three tier diagnostic system aggregating network diagnostic statistics;
an act of a filter of the three tier diagnostic system filtering the network diagnostic statistics, the filter including at least one device data limitation and at least one performance data limitation; and
an act of a user interface of the three tier diagnostic system displaying the aggregated and filtered diagnostic statistics.

11. The method in accordance with claim 10, wherein the aggregation module is a first aggregation module, the method further comprising:
an act of a second aggregation module the three tier diagnostic system aggregating the network diagnostic statistics after the act of filtering but prior to the act of displaying.

12. The method in accordance with claim 11, wherein the first and second aggregation modules are the same aggregation module.

13. The method in accordance with claim 10, wherein the network diagnostic statistics are real-time diagnostic statistics.

14. The method in accordance with claim 1, wherein the at least one performance data limitation is one of metrics or event data.

15. The method in accordance with claim 1, wherein the at least one device data limitation is one of an initiator, target, a LUN of the target, channel, a network diagnostic device identifier, a network diagnostic device type, a initiator type, or a target type.

16. A system comprising:
a computing device configured to display a user interface, the user interface configured to create a filter configured to be applied to network diagnostic statistics prior to aggregation of the network diagnostic statistics, after aggregation of the network diagnostic statistics or before and after aggregation of the network diagnostic statistics, the filter including at least one device data limitation and at least one performance data limitation.

17. The system in accordance with claim 16, wherein the at least one performance data limitation is one of metrics or event data.

18. The system in accordance with claim 16, wherein the at least one device data limitation is one of an initiator, target, a LUN of the target, channel, a network diagnostic device identifier, a network diagnostic device type, a initiator type, or a target type.

19. The system in accordance with claim 16, wherein the system is a three tier system including a data tier, portal tier, and client tier, wherein the filter is located in the portal tier.

20. The system in accordance with claim 16, wherein the system is a three tier system including a data tier, portal tier, and client tier, wherein the filter is located in the portal tier.
